(19) United States
(12) Patent Application Publication
(10) Pub. No.: US 2004/0089109 A1
(43) Pub. Date: May 13, 2004

(54) Ratchet wheel screwdriver structure

(76) Inventor: Mao-Lung Chen, Taichung City (TW)

Correspondence Address: BRUCE H. TROXELL, SUITE 1404, 5205 LEESBURG PIKE, FALLS CHURCH, VA, 22041, US

(21) Appl. No.: 10/134,598

(22) Filed: Apr. 30, 2002

(51) Int. Cl. B25B 13/46

(52) U.S. Cl. 81/63.1

(57) ABSTRACT

A ratchet wheel screwdriver structure includes a rod, a handle, and a control unit. The rod has a turning part at one end and a ratchet wheel at the other end. The ratchet wheel can be locked in the hinge hole on the handle, and the handles has a receiving hole at each side of the ratchet wheel. The receiving hole has a control unit on the spring part, which provides a recessed space for the ratchet to pass through. At the bottom of the recessed space, there is a 2-tiered block, which can prop the ratchet wheel at the bottom side to limit the ratchet wheel to turn towards it from the recessed space. An operator can press the control part of at each side of the ratchet wheel to drive the ratchet wheel in two directions.

This invention is a ratchet wheel screwdriver structure comprising of a rod, a handle, and a control unit. The rod has a turning part at one end and a ratchet wheel at the other end. The ratchet wheel can be locked in the hinge hole on the handle, and the handle has a receiving hole at each side of the ratchet wheel. The receiving hole has a control unit on the spring part, which provides a recessed space for the ratchet to pass through. At the bottom of the recessed space, there is a 2-tiered block, which can prop the ratchet wheel at the bottom side to limit the ratchet wheel to turn towards it from the recessed space. In this way, the operator can press the control part of at each side of the ratchet wheel to drive the turning part turns the ratchet wheel in two directions. And the operator doesn't need to loose then grasp the control part again to turn the screwdriver, thus eliminates the inconvenience of traditional screwdrivers.

### DESCRIPTION

This invention is a ratchet wheel screwdriver structure. With the special structure formed by the ratchet wheel and the control unit of the handle, the operator can turn the ratchet wheel in either direction, which is convenient and of practical value.

### Introduction of Traditional Screwdrivers

Screwdrivers are common tools in homes and factories. It is well known that a typical screwdriver comprises of a handle and metal rod on the front, and the rod has a crossed or straight end. When using the screwdriver, the operator holds the handle and revolves the screwdriver to screw down/up screws.

However, that structure has its shortcoming, and may be unsatisfactory and inconvenient. For example, the operator has to loose then grasp the handle again to adjust the holding position, because that the handle and the turning part is an integral structure. Therefore it is urgent needs to provide a screwdriver structure that can be turned without loose then grasp the handle.

In consideration of the shortcoming and inconvenience of traditional screwdrivers, the inventor introduced a ratchet wheel screwdriver structure to solve those problems for good.

The primary purpose of this invention is to provide a ratchet wheel screwdriver structure, the rod of which is locked at one end in the hinge hole of the handle with a ratchet wheel. There is a control part at each end of the ratchet wheel, and the control part is engaged to the ratchet wheel at the bottom through a 2-tiered block. When the operator presses the control part, the tiered block will clinch and un-clinch the ratchet wheel to turn it, which removes the inconvenience of traditional screwdrivers.

### INSTRUCTION OF DRAWINGS

FIG. 1 is a sketch map of this invention.

FIG. 2 is an exploded view of this invention.

FIG. 3 is the sketch map of the structure composed of the rod and the hinge hole on the handle.

FIG. 4 is the sketch map of the structure of the rod of this invention in the original state.

FIG. 5 is the sketch map of the invention revolving in clockwise direction.

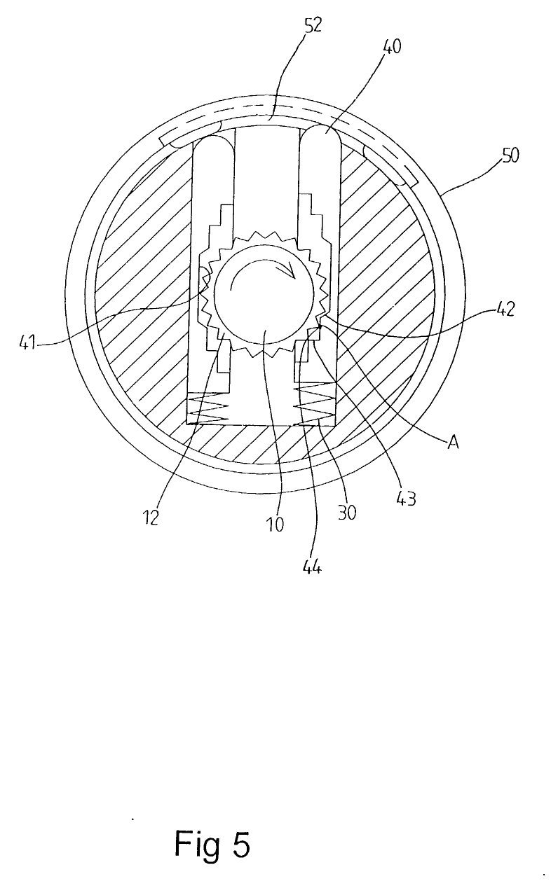

FIG. 6 is the sketch map of the invention revolving in counter clockwise direction.

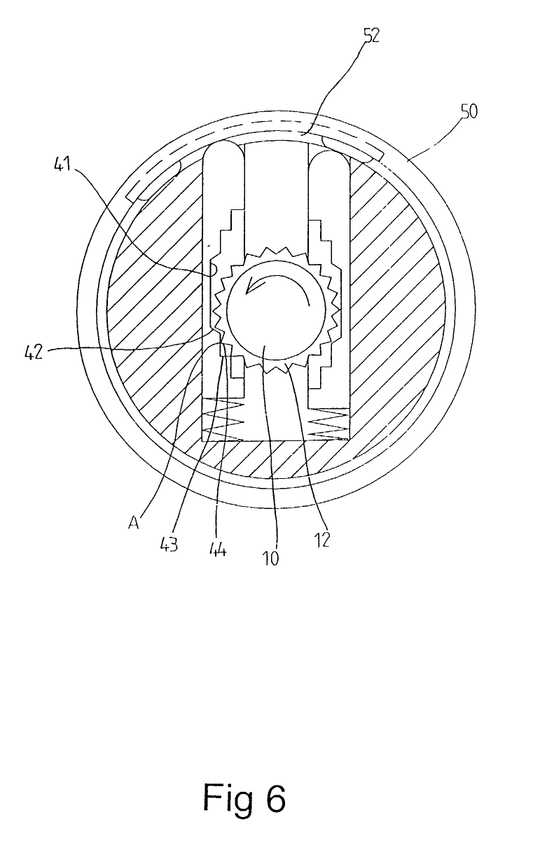

### FIGURE NUMBERS IN THE DRAWINGS

(10) Rod
(11) Turning Part
(12) Ratchet Wheel
(13) Locating Slot
(20) Handle
(21) Hinge Hole
(22) Screw Bolt
(23) Receiving Hole
(24) Protruding Pole
(30) Spring
(40) Control Unit
(41) Top End
(42) and (43) Tiers
(44) 2-Tiered Block
(50) Outer Case
(51) Annular Slot
(52) Control Slot

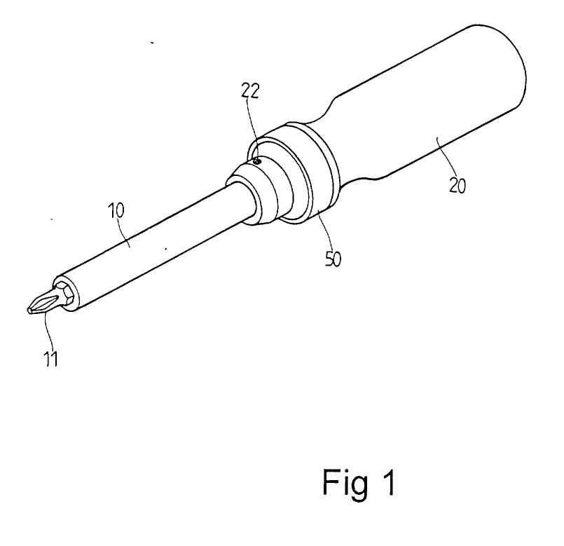

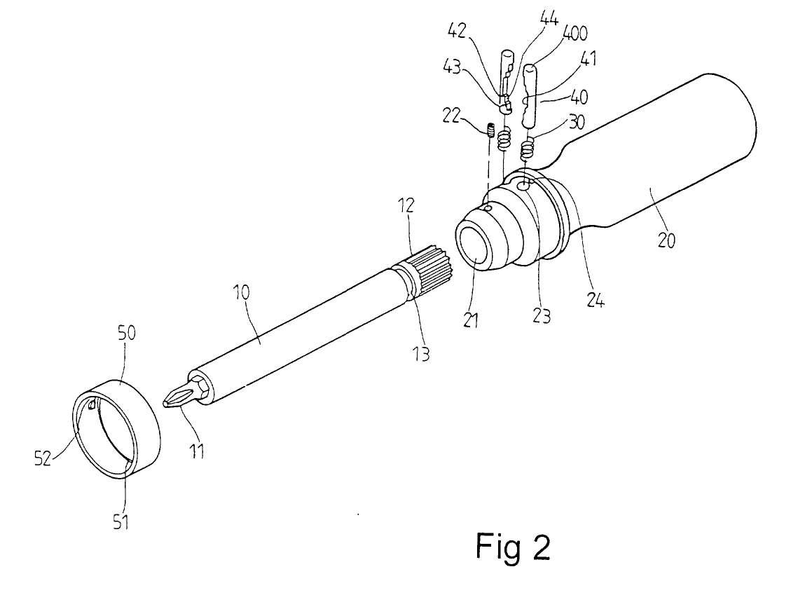

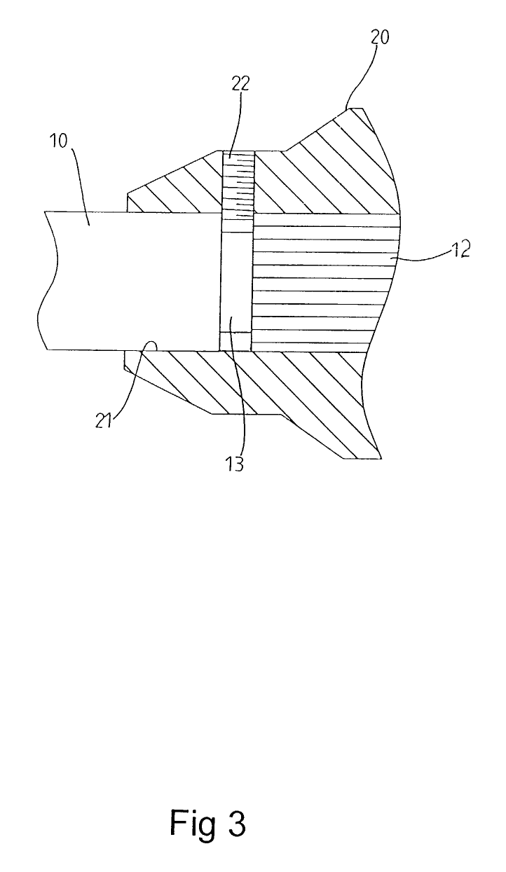

Please see FIG. 1 and FIG. 2. This invention comprises mainly of a rod (10), a handle (20) and a control unit (40), wherein the rod (10) has a turning part (11) at one end and a ratchet wheel (12) at the other end. The rod (10) has a locating slot (13) near ratchet wheel 12, which can pass through the hinge hole (21) in handle 20. A screw bolt (22) can be fixed between the two sidewalls of locating slot 13, as shown in FIG. 3, to lock rod 10 onto handle 20 through the hinge hole.

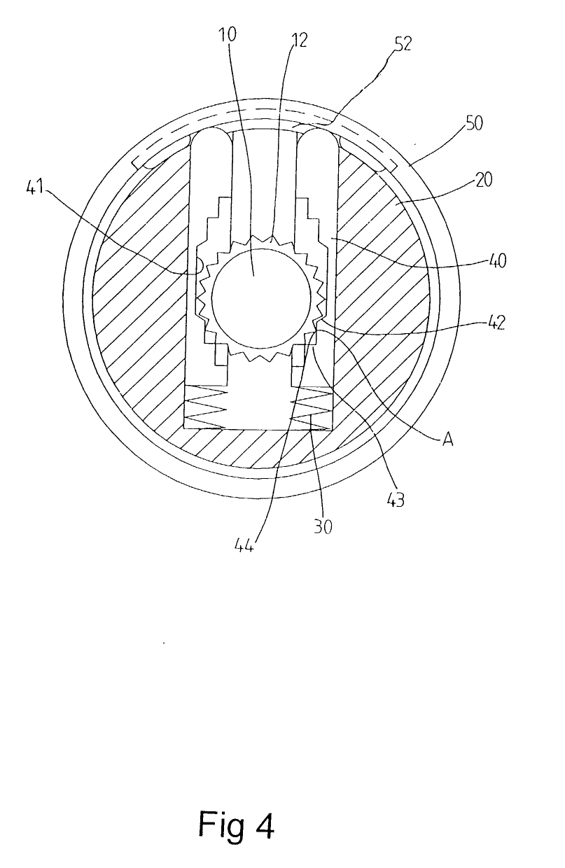

Please see FIG. 2 and FIG. 4. Handle 20 has a receiving hole (23) at each side of ratchet wheel 12 of rod 10. The receiving hole (23) should extend at least to the lower part of ratchet wheel 12. There is a spring (30) at the bottom of receiving hole 23, and on spring 30 there is a control part (40), which protrudes out of handle 20 under the pressure of spring 30. There is a recessed space (41) at the center of the control part (40), and ratchet wheel 12 can rightly pass through it. At the bottom of recessed space 41 there is a tiered (tier 42 and tier 43) block 44, which can prop ratchet wheel 12 at the bottom under the pressure of spring 30. The control part (40) can also be mounted aslant to attain the similar functionality, and in that case, the lower part of it will lie under ratchet wheel 12. When assembling the device, the operator can put spring 30 and control unit 40 in receiving hole 23 respectively, then press the two control parts (40) to let ratchet wheel 12 of rod 10 pass through recessed space 41 of it. When the control unit is released, block 44 of control unit 40 will clinch the bottom sides of ratchet wheel 12 to form the structure shown in FIG. 4.

As shown in FIG. 4, when the ratchet wheel (12) revolves in clockwise direction, it will push left block 44 at point A, then control unit 40 can't move in side direction due to the blocking of receiving hole 23. As the result the revolving action is blocked. When

1. A ratchet wheel screwdriver structure comprising of a rod, a handle and a control unit, wherein:
the rod has a ratchet wheel on one end, which can pass through the hinge hole on the handle to lock the rod on the handle;
the handle has a control part on the spring at each end of the said ratchet wheel of the rod; a block is provided at the bottom of each control part to control the ratchet wheel, i.e., the block can prop the ratchet wheel at the bottom sides under the pressure of the spring of the control unit, and when the operator presses a control part, the block will clinch and un-clinch the ratchet wheel sequentially to revolve the rod, which will in turn screw up/down the screw.

2. The ratchet wheel structure as in claim 1, wherein the rod has a locating slot near the ratchet wheel, and the handle has a screw blot at the position corresponding to the locating slot; the screw blot can be fixed between the two side walls of the locating slot to lock the rod onto the handle through the said hinge hole.

3. The ratchet wheel structure as in claim 1, wherein the handle has a receiving hole at each end of the ratchet wheel of the rod; there is a spring at the bottom of the receiving holes, and there is a control unit (2 control parts) on the spring and extrudes out of the handle under the pressure of that spring.

4. The ratchet wheel structure as in claim 1 or claim 3, wherein each control part has a recessed space at the center, and the ratchet wheel can pass through the two recessed spaces; at the bottom of each recessed space there is a 2-tiered block propping the cachet wheel at the bottom side.

5. The ratchet wheel structure as in claim 1, wherein the handle has an outer case, and there is a protruding pole on handle 20 and an annular slot on outer case 50 at the corresponding position; The outer case has a control slot within the control scope of the two control parts (40) to limit them in the control slot.
